(19) United States
(12) Patent Application Publication
(10) Pub. No.: US 2005/0195430 A1
(43) Pub. Date: Sep. 8, 2005

(54) Image registration apparatus, image retrieval apparatus, image management method, and storage medium

(75) Inventors: Koichiro Shinohara, Kanagawa (JP); Taro Terao, Kanagawa (JP); Katsuhiko Sugawara, Kanagawa (JP); Masaru Okutsu, Kanagawa (JP); Yoshio Kanesawa, Kanagawa (JP); Yu Tsuda, Kanagawa (JP); Osamu Ide, Kanagawa (JP); Koji Aikawa, Kanagawa (JP); Yutaka Nogami, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD

(21) Appl. No.: 11/022,942

(22) Filed: Dec. 28, 2004

(30) Foreign Application Priority Data
Mar. 4, 2004 (JP) P2004-061137

(51) Int. Cl. G06F 13/00; G06F 3/12; G06F 15/00; G06F 7/00

(52) U.S. Cl. 358/1.15; 358/403; 358/1.16; 707/104.1

(57) ABSTRACT

A system includes an image formation apparatus, an image retrieval server, and image storage servers, and a network for connecting them. The image formation apparatus forms an image based on image data, records the image data in a predetermined storing location on the image storage servers, converts the image data under a predetermined rule to generate an image identification information as a key in order to read the image data from the storing location, and outputs the image identification information. Upon reception of an image data retrieval request together with an image identification information, the image retrieval server determines that the image data whose result of conversion under the predetermined rule is equal to the image identification information, among at least one image data stored in a predetermined storing location on the image storage servers, is the image data to be retrieved, and outputs its information.

### BACKGROUND OF THE INVENTION

1. Field of the Invention

The invention relates to an image registration apparatus for registering image data in a server computer (thereafter, “server”) and the like.

2. Description of the Related Art

In recent years, it has become a common practice to handle an image of a photo, etc., as digital data and to view the image, usually browsing software installed in a digital camera (containing a mobile telephone with a camera), a PC (personal computer), etc., has been used.

However, the digital camera, etc., is inconvenient for use for the purpose of enjoying viewing images because the size of a display for displaying an image is limited. The PC, etc., can display an image largely to some extent and enables the user to view images in almost the same way the user views an album. However, if the user attempts to view images at a place where the PC, etc., is not installed, it becomes necessary for the user to move the PC, etc., to the place; it is cumbersome.

Therefore, the desire to print out even an image involving digital data still exists. For example, an image can be printed out from digital data on a printer possessed by an individual, a printer installed in a DPE shop or a convenient store, etc.

By the way, once an image is thus printed out, the digital data as the source is often erased from the record medium such as a hard disk or a memory card, because the capacity of the record medium possessed by an individual is limited and a kind of peace of mind is provided as the image is recorded on the paper basis as it is printed out.

However, there might be a possibility that circumstances where the printed-out image is lost or broken or the user wants to edit the source digital data to again print out or the like will later occur. In such a case, no action can be taken unless the original data is left.

Then, in a related art, if there is a possibility that the source digital data will be used after the image is printed out, to print out the image, the digital data is linked with key information to read the digital data (for example, user ID) and then is uploaded to a server. (For example, see JP-A-2002-73794.)

JP-A-2002-73794 (pages 4 and 5, FIGS. 4 and 5) is referred to as a related art.

However, the invention in JP-A-2002-73794 assumes that the service provider manages the correspondence between the key information and the image data, and it is feared that the invention may be unable to deal with a request for storing the image data over a long term of 10 to 20 years, because there is no guarantee that the service provider will survive over such a long term. If the user keeps track of the image data storage location based on the network address, there is a possibility that the image data will be fetched still after the service provider ceases to exist, but there is no guarantee that the same image data will exist at the same network address in 10 to 20 years. Therefore, the user making a request for storing image data is haunted by a feeling of uneasiness such that the user will be unable to keep track of where the image data exists, and the user cannot make a request for storing image data with peace of mind.

### SUMMARY OF THE INVENTION

The object of the invention is to enable the user to make a request for storing image data over a long term with peace of mind.

The object of the invention is to enable the user to reliably retrieve image data registered over a long term.

In the invention, an image identification information as a key which is necessary to retrieve image data is generated based on the image data, and is sent to the user. An image registration apparatus of the invention includes an image data acquisition section that acquires image data; an image data record section that records the image data acquired by the image data acquisition section in a predetermined storing location; an information generation section that converts the image data acquired by the image data acquisition section under a predetermined rule to generate an image identification information as a key which is necessary to read the image data from the storing location; and an information output section that outputs the image identification information generated by the information generation section. The image registration apparatus of the invention may further include an image formation section that forms an image based on the image data acquired by the image data acquisition section, wherein when the image formation section forms an image, the image data record section may record the image data. The hash value of the image data acquired by the image data acquisition section can be used as the image identification information generated by the information generation section.

The invention can also be interpreted as an image retrieval apparatus for retrieving image data using the image identification information sent by the image registration apparatus. The image retrieval apparatus of the invention includes a retrieval request reception section that receives a request for retrieving image data together with an image identification information as a key which is necessary to read the image data; a retrieval target determination section that determines that image data whose result of conversion under a predetermined rule is equal to the image identification information, among at least one image data stored in a predetermined storing location, is the image data to be retrieved when the retrieval request reception section receives the request for retrieving image data; and a retrieval result output section that outputs information of the image data to be retrieved, which is determined by the retrieval target determination section.

Further, the invention can also be interpreted as an image management method of registering and retrieving image data using a computer. The image management method of the invention includes the steps of: storing specific image data acquired from a registration requester; sending an image identification information generated by converting the stored specific image data under a predetermined rule to the registration requester; acquiring a request for retrieving the specific image data together with the image identification information from a retrieval requester; determining that image data whose result of conversion under a predetermined rule is equal to the image identification information, among at least one image data stored in a predetermined storing location, is the specific image data; and outputting information of the determined specific image data to the retrieval requester.

On the other hand, the invention can also be interpreted as a storage medium readable by a computer, the storage medium storing a program of instruction executable by the computer to perform predetermined functions. A storage medium stores the program of instruction executable by the computer to perform functions of: acquiring image data; recording the acquired image data in a predetermined storing location; converting the acquired image data under a predetermined rule to generate an image identification information as a key which is necessary to read the image data from the storing location; and outputting the generated image identification information. Another storage medium stores the program of instruction executable by the computer to perform functions of: receiving a request for retrieving image data together with an image identification information as a key which is necessary to read the image data; determining that image data whose result of conversion under a predetermined rule is equal to the image identification information, among at least one image data stored in a predetermined storing location, is the image data to be retrieved when the retrieval request reception section receives the request for retrieving image data; and outputting information of the image data determined to be retrieved.

According to the image registration apparatus, the image retrieval apparatus, the image management method, the storage medium, it is possible for the user to make a request for storing image data over a long term with peace of mind.

### BRIEF DESCRIPTION OF THE DRAWINGS

FIG. 1 is a block diagram to show an example of the general configuration of a system incorporating an embodiment of the invention;

FIG. 2 is a block diagram to show the functional configuration of an image formation apparatus in the embodiment of the invention;

FIG. 3 is a block diagram to show the functional configuration of an image retrieval server in the embodiment of the invention;

FIG. 4 is a drawing to show an example of the storage contents of a cache storage section in the embodiment of the invention;

FIG. 5 is a drawing to show an example of the storage contents of a directory storage section in the embodiment of the invention;

FIG. 6 is a flowchart to show the processing operation of the image formation apparatus in the embodiment of the invention; and

FIG. 7 is a flowchart to show the processing operation of the image retrieval server in the embodiment of the invention.

### DETAILED DESCRIPTION OF THE PREFERRED EMBODIMENTS

An embodiment of the invention will be explained in detail with reference to the accompanying drawings.

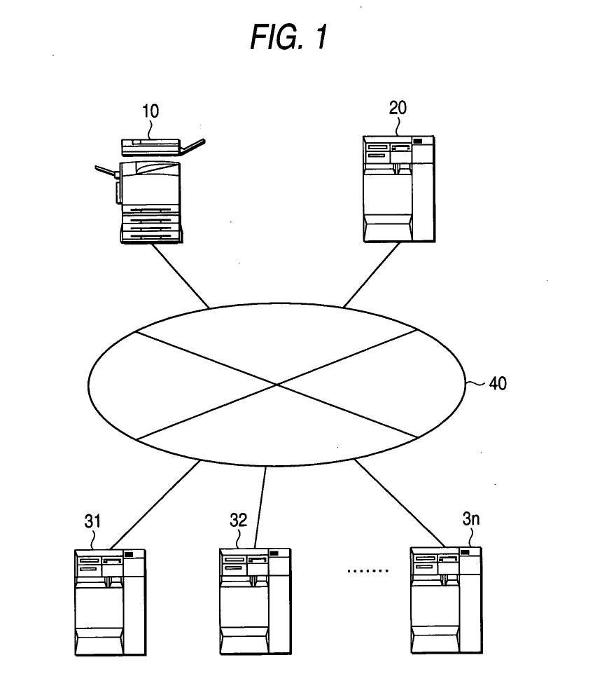

FIG. 1 shows an example of the general configuration of a system in an embodiment of the invention. This system includes an image formation apparatus 10, an image retrieval server 20, and image storage servers 31, 32, . . . , 3n, which are connected to each other through a network 40.

The image formation apparatus 10 includes at least a scanning section having a mechanism for reading information of the light and shade and the position of a two-dimensional image from an original placed on a platen, a printing section having a mechanism for reproducing an image based on specified image data on a medium of paper, etc., a controller for controlling the sections, and storage for storing image data, data required for controlling and the like. The image formation apparatus 10 may also include a UI section for the user to set conditions concerning image formation, etc., a media reader for reading image data as a source for forming an image from a record medium, a communication section for receiving image data as a source for forming an image by conducting wired or radio communications, etc., as required.

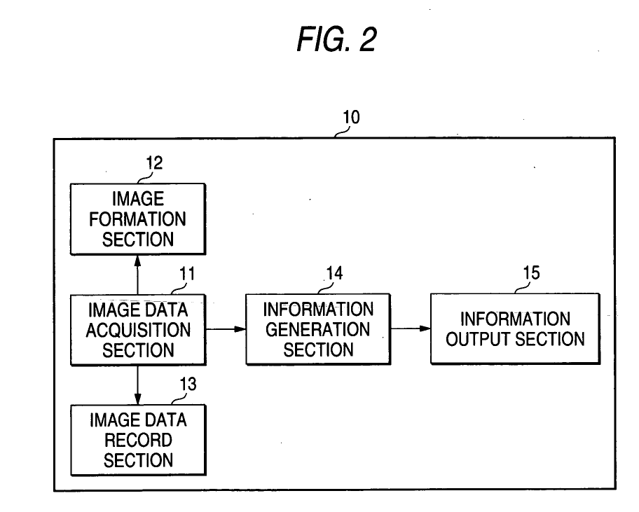

Next, the functional configuration of the image formation apparatus 10 will be discussed with reference to FIG. 2.

As shown in FIG. 2, the image formation apparatus 10 includes an image data acquisition section 11, an image formation section 12, an image data record section 13, an information generation section 14, and an information output section 15.

The image data acquisition section 11 acquires image data from the media reader, the communication section, or the storage, and the image formation section 12 forms an image based on the acquired image data. The image data record section 13 records the acquired image data in a predetermined storing location on the image storage servers 31, 32, . . . , 3n. The information generation section 14 converts the acquired image data under a predetermined rule to generate an image identification information as a key which is necessary to read the image data. The information output section 15 outputs the generated image identification information.

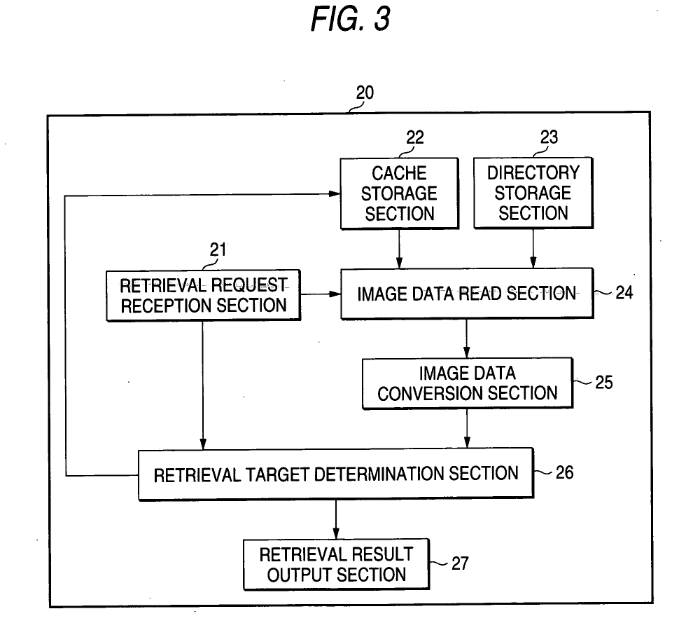

Next, the functional configuration of the image retrieval server 20 will be discussed with reference to FIG. 3.

As shown in FIG. 3, the image retrieval server 20 includes a retrieval request reception section 21, a cache storage section 22, a directory storage section 23, an image data read section 24, an image data conversion section 25, a retrieval target determination section 26, and a retrieval result output section 27.

The retrieval request reception section 21 receives a retrieval request together with an image identification information as a key used for image data retrieval. The cache storage section 22 stores the correspondence between the image identification information of retrieved image data and the file name in the image storage servers 31, 32, . . . , 3n. The directory storage section 23 stores a directory list which shows the storing locations where the image data to be retrieved can exist. The image data read section 24 reads image data from the storing location on the image storage servers 31, 32, . . . , 3n. The image data conversion section 25 converts the read image data under the same rule as that used by the information generation section 14. The retrieval target determination section 26 makes a comparison between the image identification information received by the retrieval request reception section 21 and the conversion result of the image data conversion section 25, and determines that the read image data is the image data to be retrieved if they equal. The retrieval result output section 27 outputs information of the determined image data to be retrieved.

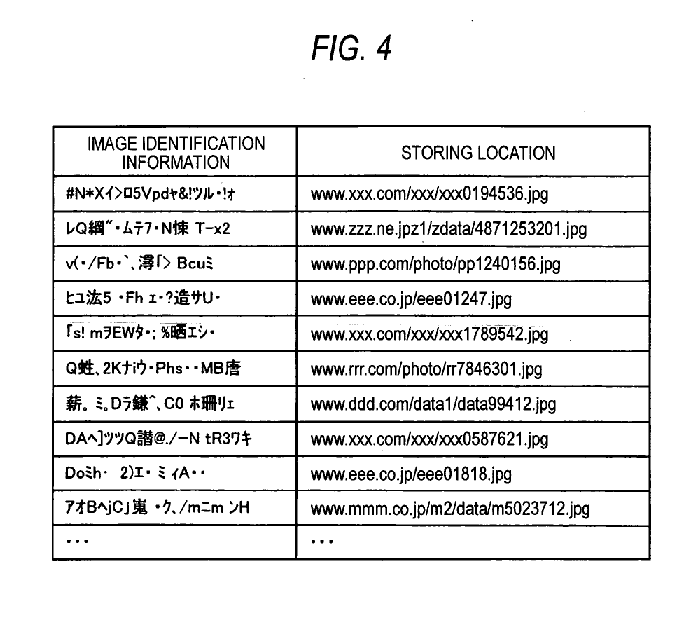

An example of the storage contents of the cache storage section 22 will be discussed with reference to FIG. 4.

As shown in FIG. 4, regarding the image data whose retrieval was requested in the past, the cache storage section 22 stores the correspondence between the image identification information used as a key for retrieval (for example, hash value) and information concerning the storing location at the point in time when the image data is retrieved (directory and file name). The image identification information is a meaningless character string provided by converting the image data under the predetermined rule and thus is represented as a meaningless string of alphabet, katakana, and Chinese characters in FIG. 4.

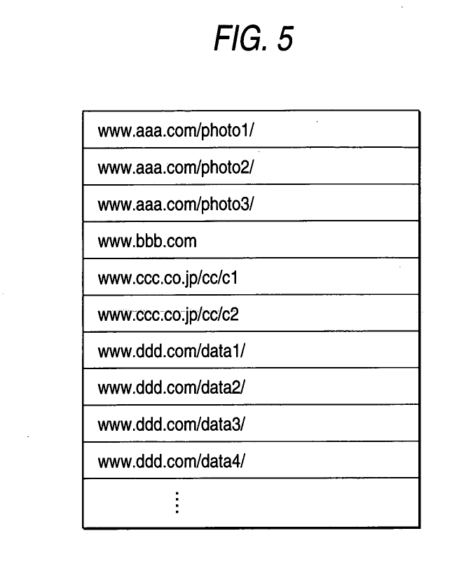

An example of the storage contents of the directory storage section 23 will be discussed with reference to FIG. 5.

As shown in FIG. 5, the directory storage section 23 defines a list of directories wherein image data is to be retrieved upon reception of an image data retrieval request. That is, the image data read section 24 reads the image data existing under the directories contained in the list in order. As shown in FIG. 5, the directories at any levels in the hierarchical structure of URL (Uniform Resource Locator) may be set.

The operation of the system of the embodiment described above will be discussed below in detail:

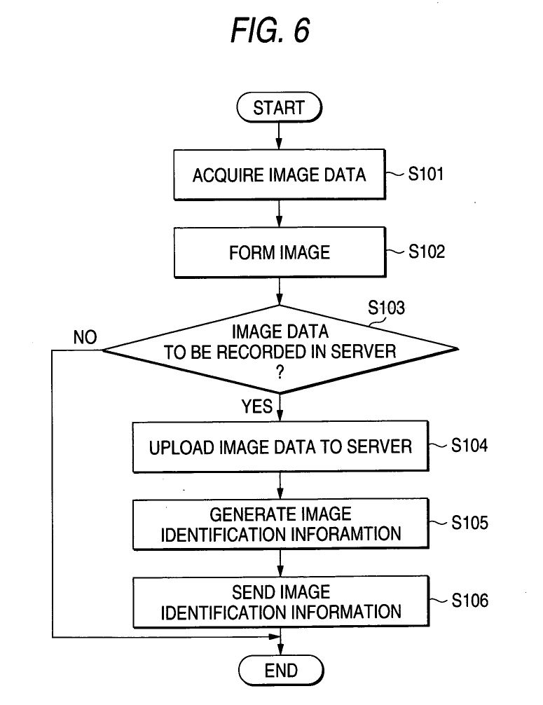

FIG. 6 is a flowchart to show the operation of the image formation apparatus 10.

First, the image data acquisition section 11 acquires image data from the media reader, the communication section, or the storage (step S101). In the case of acquiring the image data from the media reader, the user inserts the record medium storing the image data as the source for image formation into a predetermined insertion slot, and then gives an image formation command. In the case of acquiring the image data from the communication section, the user opposes the mobile telephone storing the image data as the source for image formation to a predetermined communication section (infrared reception section, Bluetooth chip, etc.) or connects the mobile telephone and the image formation apparatus 10 by a cable and then gives an image formation command.

Next, the image formation section 12 received the image data acquired by the image data acquisition section 11 and forms an image based on the image data (step S102). Specifically, an electrostatic latent image is written onto a photoconductor drum (not shown) based on the image data and a toner image formed on the photoconductor drum is transferred onto paper and is fixed by a fixing section, thereby forming an image.

Upon completion of forming the image, the image formation apparatus 10 inquires of the user if the user will upload the image data as the source for image formation to the server (step S103).

If the user responds to the inquiry with no selection of uploading the image data to the server, the processing is terminated. If the user selects uploading the image data to the server, the image data record section 13 records the image data in a predetermined storing location on the image storage servers 31, 32, . . . , 3n (step S104). The information generation section 14 generates image identification information as a key which is necessary to retrieve the recorded image data afterward (step S105).

For example, the hash value provided by applying a hash function to the image data can be used as the image identification information. Representative hash functions include “SHA-1,” “MD5,” etc. The former is an algorithm for generating a 160-bit hash value from data of 2⁶⁴ bits or less, and the latter is an algorithm for generating a 128-bit hash value from data of any bit length.

The advantages of using the hash value as the image identification information are that it is easy to generate the hash value from the image data, but it is extremely difficult to generate the image data from the hash value (the hash value is generated by an irreversible unidirectional function) and that the probability that the same hash value will be generated from different image data is almost zero. That is, if a third person sees the hash value, it is impossible to analogize the image as the source of the hash value and if hash values are generated from every image data, it is almost impossible that the same hash value will appear. Moreover, the hash value is key information provided by processing the recorded image data itself and thus is information that can continue to function permanently as key information unlike closed information for a specific service provider such as the user ID.

Last, the information output section 15 sends the image identification information generated by the information generation section 14 (step S106). The image identification information needs to be able to almost uniquely identify image data and thus generally become a considerable number of bits. Therefore, specifically it is desirable that the image identification information should be output to a record medium such as paper or a memory card or output to a hard disk of a PC, etc., possessed by the user using electronic mail, thereby sending the image identification information. Particularly, to output the image identification information to a medium such as paper, it would be efficient to also output the image identification information to the medium such as paper to which the image formed at step S102 is output. At the time, the image identification information may be converted into a bar code, etc., for output so that it is easily read through a scanner later.

In FIG. 6, after completion of image formation, the image data as the source is uploaded to the server. However, the image data may be uploaded to the server at the same time as the image formation or before the image formation is started.

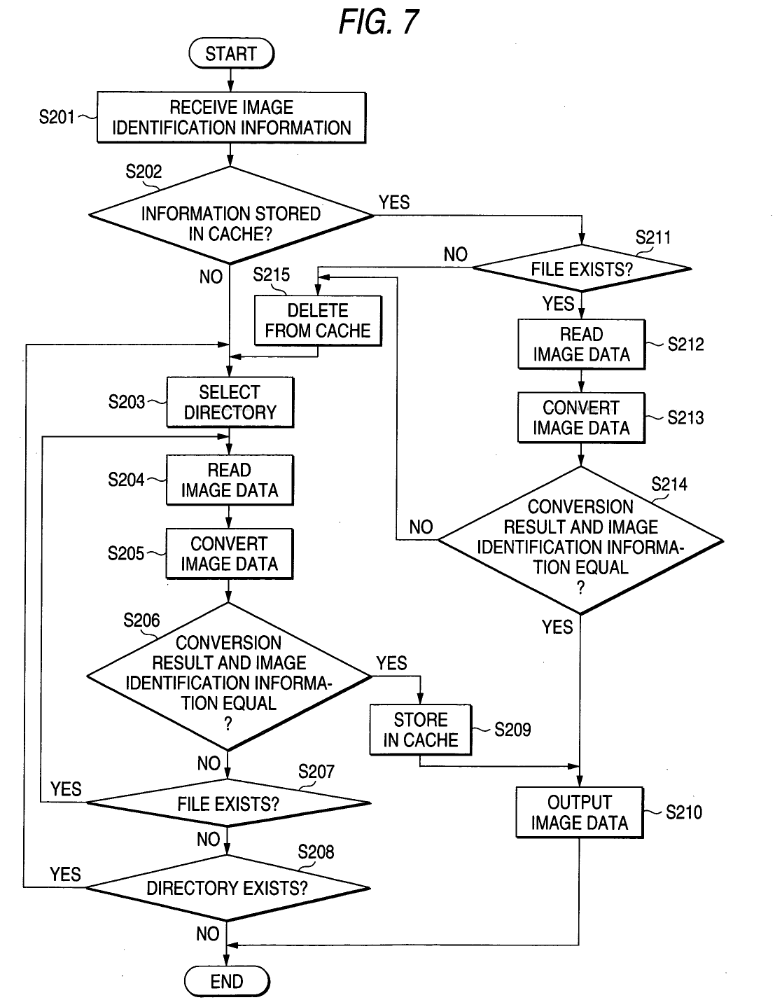

FIG. 7 is a flowchart to show the operation of the image retrieval server 20. The user recording the image data in the server in FIG. 6 or the user inheriting the image identification information sent in FIG. 6 from that user enters the image identification information and makes a request for retrieving the image data, whereby the operation of the image retrieval server 20 is started. The user may enter the image identification information in a terminal such as the PC possessed by the user or may enter the image identification information in the image formation apparatus 10 if the image formation apparatus 10 includes a function of transmitting the image identification information to the image retrieval server 20.

First, the retrieval request reception section 21 receives the image identification information thus entered (step S201), records the image identification information, and passes the image identification information to the image data read section 24. Next, the image data read section 24 determines whether or not information concerning the passed image identification information is stored in the cache storage section 22 shown in FIG. 4 (step S202).

If image data was retrieved in the past with the image identification information as a key, there is a possibility that the correspondence between the image identification information and the file name may be stored in the cache storage section 22. However, here it is assumed that such correspondence is not stored in the cache storage section 22.

In this case, one directory is selected out of the list of the directories stored in the directory storage section 23 shown in FIG. 5 (step S203), and image data is read from a file under the directory on the image storage servers 31, 32, . . . , 3n (step S204). The image data conversion section 25 converts the read image data under the same rule as that used at step S105 in FIG. 6 (step S205).

Then, the retrieval target determination section 26 makes a comparison between the image identification information received by the retrieval request reception section 21 and the conversion result of the image data conversion section 25 and determines whether or not they equal (step S206). For example, if the predetermined rule is a hash function, the retrieval target determination section 26 makes a comparison between the hash value received by the retrieval request reception section 21 and the hash value provided by the image data conversion section 25 applying the hash function to the image data.

If they do not equal, the read image data is not the image data to be retrieved and thus whether or not another file exists under the directory is determined (step S207). If a file exists, the process returns to step S204. On the other hand, if no file exists, whether or not a director not yet selected out of the directory list exists is determined (step S208). If a directory not yet selected exists, the process returns to step S203.

Likewise, while the directories are selected in order one at a time out of the list of the directories stored in the directory storage section 23 shown in FIG. 5, image data is read in order from the files under the selected directory and the processing is repeated until the conversion result equal to the image identification information received at step S201 appears (until the determination result at step S206 becomes YES). If the determination result at step S208 becomes NO with the determination result at step S206 not becoming YES, the processing is terminated.

On the other hand, if it is determined at step S206 that the image identification information received by the retrieval request reception section 21 and the conversion result of the image data conversion section 25 equal, the read image data is the image data to be retrieved and thus the correspondence between the image identification information and the file name of the image data is stored in the cache storage section 22 (step S209) and the image data is output (step S210). Alternatively, information of the storing location, etc., of the image data may be output.

If it is determined at step S202 that the correspondence between the image identification information and the file name is stored in the cache storage section 22, the following processing is performed:

The image data read section 24 determines whether or not the file indicated by the file name exists on the network (step S211), because there is also a possibility that the file may later be deleted or be moved to another storing location even if the file existed in the preceding retrieval time.

If the file exists, the image data is read from the file (step S212) and the read image data is converted under the same rule as that used at step S105 in FIG. 6 (step S213). Whether or not the image identification information received at step S201 and the conversion result at step S213 equal is determined (step S214).

If it is determined at step S214 that the image identification information and the conversion result equal, the image data in the storing location associated with the image identification information in the cache storage section 22 is the image data to be retrieved and the image data is output (step S210). Alternatively, information of the storing location, etc., of the image data may be output.

On the other hand, if it is determined at step S211 that the file does not exist, it is considered that the previously retrieved image data with the corresponding information stored in the cache storage section 22 does not exist or if it is determined at step S214 that the image identification information and the conversion result do not equal, it is considered that the previously retrieved image data with the corresponding information stored in the cache storage section 22 is already replaced with different image data. Then, the information concerning the image identification information is deleted from the cache storage section 22 (step S215) and steps S203 to S208 are executed to determine the image data to be retrieved.

Thus, in the embodiment, to upload image data to the server, image identification information, such as the hash value, is generated and is sent to the user, whereby it is made possible for the user to make a request for storing image data with a kind of peace of mind such that the user can reliably fetch the image data regardless of where the image data exists on the network. If the user has only the image identification information, the user will be able to reliably fetch the stored image data (so long as the image data exists anywhere) in 10 to 20 years.

In the embodiment, the image data is uploaded to the server from the image formation apparatus, but can also be updated from a general computer such a PC. That is, the apparatus for uploading the image data to the server can be called “image registration apparatus” as attention is focused on the function of registering the image data in the server. Likewise, the image retrieval server 20 retrieves the image data, but any other computer than the server can also retrieve the image data. Therefore, it can be called “image retrieval apparatus” as attention is focused on the function of retrieving the image data.

In the embodiment, as the rule used to generate image identification information from image data, only one specific rule is assumed and to retrieve image data, the rule to be used is not specified, etc., either. Such a mode in which the used rule is not considered is also possible, for example, if the operator operating the image formation apparatus 10 and the image retrieval server 20 uses only one specific rule. However, a mode is also possible wherein the operator operating the image formation apparatus 10 and the image retrieval server 20 uses a plurality of rules properly to generate image identification information. In this case, the information output section 15 may send information of the conversion rule (for example, SHA-1, MD5, etc.) as well as the image identification information at step S106 in FIG. 6, and the user may enter the conversion rule sent together with the image identification information at step S201 in FIG. 7. This makes it possible to use the same rule as that used at step S105 in FIG. 6 at step S205 or S213 in FIG. 7.

Further, only the image data is uploaded to the server at step S104 in FIG. 6 and the image data is read and is converted each time at steps S204 and S205 or steps S212 and S213 in FIG. 7. However, the image identification information generated at step S105 in FIG. 6 may also be previously uploaded to the server and only the image identification information may be read at step S204 or step S212.

1. An image registration apparatus comprising:
an image data acquisition section that acquires image data;
an image data record section that records the image data acquired by the image data acquisition section in a predetermined storing location;
an information generation section that converts the image data acquired by the image data acquisition section under a predetermined rule to generate an image identification information as a key which is necessary to read the image data from the storing location; and
an information output section that outputs the image identification information generated by the information generation section.

2. The image registration apparatus according to claim 1, further comprising:
an image formation section that forms an image based on the image data acquired by the image data acquisition section,
wherein when the image formation section forms an image, the image data record section records the image data.

3. The image registration apparatus according to claim 1,
wherein the information generation section calculates a hash value of the image data acquired by the image data acquisition section as the image identification information.

4. The image registration apparatus according to claim 1,
wherein the information output section further outputs an information concerning the rule used in order to generate the image identification information by the information generation section.

5. An image retrieval apparatus comprising:
a retrieval request reception section that receives a request for retrieving image data together with an image identification information as a key which is necessary to read the image data;
a retrieval target determination section that determines that image data whose result of conversion under a predetermined rule is equal to the image identification information, among at least one image data stored in a predetermined storing location, is the image data to be retrieved when the retrieval request reception section receives the request for retrieving image data; and
a retrieval result output section that outputs information of the image data to be retrieved, which is determined by the retrieval target determination section.

6. The image retrieval apparatus according to claim 5,
wherein the retrieval target determination section determines that image data whose result of conversion under the predetermined rule is equal to the image identification information, among at least one image data stored in a previously defined storing location, is the image data to be retrieved.

7. The image retrieval apparatus according to claim 5,
wherein the retrieval target determination section determines that image data previously associated with the image identification information received by the retrieval request reception section is the image data to be retrieved, in a case that a result of converting the associated image data under the predetermined rule is equal to the image identification information.

8. An image management method of registering and retrieving image data using a computer, the image management method comprising the steps of:
storing specific image data acquired from a registration requester;
sending an image identification information generated by converting the stored specific image data under a predetermined rule to the registration requester;
acquiring a request for retrieving the specific image data together with the image identification information from a retrieval requester;
determining that image data whose result of conversion under a predetermined rule is equal to the image identification information, among at least one image data stored in a predetermined storing location, is the specific image data; and
outputting information of the determined specific image data to the retrieval requester.

9. The image management method according to claim 8,
wherein in the sending step, a hash value of the specific image data is sent as the image identification information, and
in the determining step, image data whose hash value is equal to the sent hash value among at least one image data stored in the predetermined storing location is the specific image data.

10. A storage medium readable by a computer, the storage medium storing a program of instruction executable by the computer to perform functions of:
acquiring image data;
recording the acquired image data in a predetermined storing location;
converting the acquired image data under a predetermined rule to generate an image identification information as a key which is necessary to read the image data from the storing location; and
outputting the generated image identification information.

11. The storage medium according to claim 10,
wherein the recording function is a function of recording the acquired image data when an image is formed based on the acquired image data.

12. The storage medium according to claim 10,
wherein the function of generating the image identification information is a function of calculating a hash value of the acquired image data as the image identification information.

13. The storage medium according to claim 10,
wherein the function of outputting the image identification information is a function of further outputting an information concerning the rule used in order to generate the image identification information.

14. A storage medium readable by a computer, the storage medium storing a program of instruction executable by the computer to perform functions of:
receiving a request for retrieving image data together with an image identification information as a key which is necessary to read the image data;
determining that image data whose result of conversion under a predetermined rule is equal to the image identification information, among at least one image data stored in a predetermined storing location, is the image data to be retrieved when the retrieval request reception section receives the request for retrieving image data; and
outputting information of the image data determined to be retrieved.

15. The storage medium according to claim 14,
wherein the function of determining the image data to be retrieved is a function of determining that image data whose result of conversion under the predetermined rule is equal to the image identification information, among at least one image data stored in a previously defined storing location, is the image data to be retrieved.

16. The storage medium according to claim 14,
wherein the function of determining the image data to be retrieved is a function of determining that image data previously associated with the image identification information received by the retrieval request reception section is the image data to be retrieved, in a case that a result of converting the associated image data under the predetermined rule is equal to the image identification information.
